(19) United States
(12) Patent Application Publication
(10) Pub. No.: US 2025/0317890 A1
(43) Pub. Date: Oct. 9, 2025

(54) LOCATION-BASED SECURITY FOR WI-FI NETWORKS

(71) Applicant: MaxLinear, Inc., Carlsbad, CA (US)

(72) Inventor: Saju Palayur, Poway, CA (US)

(73) Assignee: MaxLinear, Inc., Carlsbad, CA (US)

(21) Appl. No.: 19/171,248

(22) Filed: Apr. 5, 2025

Related U.S. Application Data
(60) Provisional application No. 63/575,545, filed on Apr. 5, 2024.

(51) Int. Cl. H04W 64/00; H04B 7/06; H04L 41/16; H04W 4/021

(52) U.S. Cl. CPC H04W 64/00; H04B 7/0626; H04L 41/16; H04W 4/021

(57) ABSTRACT

An access point (AP) may include a processing device. The processing device may identify, at the AP, one or more of sounding data, channel state information (CSI), beamforming matrix, or round trip timing (RTT) for a station (STA). The processing device may compute, at the AP, a location for the STA based on the one or more of the sounding data, the CSI, the beamforming matrix, or the RTT in which the location may be computed relative to a geo-fence. The processing device may compute, at the AP, a network access for the STA based on the location relative to the geo-fence.

### RELATED APPLICATION

This application claims the benefit of U.S. Provisional Application No. 63/575,545, filed Apr. 5, 2024, the disclosure of which is incorporated herein by reference in its entirety.

### FIELD

This disclosure relates to network security, and more specifically, to location-based network security for a Wi-Fi® network.

### BACKGROUND

Unless otherwise indicated herein, the materials described herein are not prior art to the claims in the present application and are not admitted to be prior art by inclusion in this section.

Wireless transmissions using the Institute of Electrical and Electronics Engineers (IEEE) 802.11 standard (e.g., Wi-Fi®) may be broadcast from an access point to one or more devices that may be located within the range of the access point broadcast. Some Wi-Fi® networks may include various forms of network security, such as encryption and/or passwords. However, vulnerabilities may exist in some Wi-Fi® networks that may be associated with the broadcast nature of the Wi-Fi® network.

The subject matter claimed in the present disclosure is not limited to implementations that solve any disadvantages or that operate only in environments such as those described above. Rather, this background is only provided to illustrate one example technology area where some examples described in the present disclosure may be practiced.

### SUMMARY

An access point (AP) may include a processing device. The processing device may identify, at the AP, one or more of sounding data, channel state information (CSI), beamforming matrix, or round trip timing (RTT) for a station (STA). The processing device may compute, at the AP, a location for the STA based on the one or more of the sounding data, the CSI, the beamforming matrix, or the RTT in which the location may be computed relative to a geo-fence. The processing device may compute, at the AP, a network access for the STA based on the location relative to the geo-fence.

A method may include one or more of: identifying, at an AP, one or more of sounding data, CSI, beamforming matrix, or RTT for a STA; computing, at the AP, a location for the STA based on the one or more of the sounding data, the CSI, the beamforming matrix, or the RTT in which the location may be computed relative to a geo-fence; or computing, at the AP, a network access for the STA based on the location relative to the geo-fence.

A computer-readable medium may include computer executable instructions. The computer executable instructions, when executed by a processing device, may cause an AP to identify, at the AP, one or more of sounding data, CSI, beamforming matrix, or RTT for a STA. The computer executable instructions, when executed by a processing device, may cause an AP to compute, at the AP, a location for the STA based on the one or more of the sounding data, the CSI, the beamforming matrix, or the RTT in which the location may be computed relative to a geo-fence. The computer executable instructions, when executed by a processing device, may cause an AP to compute, at the AP, a network access for the STA based on the location relative to the geo-fence.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example diagram of location-based security for Wi-Fi® networks.

FIG. 2 illustrates an example process flow of an access point (AP) used for location-based security for Wi-Fi® networks.

FIG. 3 illustrates an example communication system for location-based security for Wi-Fi® networks.

FIG. 4 illustrates a diagrammatic representation of a machine in the example form of a computing device within which a set of instructions, for causing the machine to perform any one or more of the methods discussed herein, may be executed.

### DETAILED DESCRIPTION

An access point in a Wi-Fi® network may broadcast a Wi-Fi signal. The Wi-Fi® signal may be received by one or more devices within a threshold proximity to the access point. Due to the nature of a broadcast Wi-Fi® signal, the Wi-Fi® signal may be accessible to devices beyond a transmission boundary. Some Wi-Fi® bands may be more capable than other Wi-Fi® bands of permeating solid objects, such as walls in a building, which may extend the range of the Wi-Fi® transmissions beyond the transmission boundary. Alternatively, or additionally, some transmission techniques, such as beamforming, may extend the range of the Wi-Fi® transmissions which may also contribute to the range of the Wi-Fi® transmissions beyond the transmission boundary.

Li-Fi networks may limit the range of a wireless transmission to wherever visible light was able to travel. In some instances, the Li-Fi networks may utilize one or more g·hn transceivers to communicate between access points and devices. The Li-Fi transmissions may include one or more modulations to the visible spectrum, ultraviolet spectrum, and/or infrared spectrum such that the Li-Fi transmissions may be limited in range to where the visible light may be able to traverse. The limitations to the transmission range of a Li-Fi transmission may add security to such Li-Fi transmissions as the signal may be accessible in a limited environment whereas a Wi-Fi® signal may be present within a range supported by the Wi-Fi band, the access point, and/or the transmission techniques as described herein.

Li-Fi networks have not gained the same popularity and use as Wi-Fi® networks, but do include at least some benefits relative to the Wi-Fi® networks. For example, the limitation on the range of the Li-Fi transmissions may offer increased security relative to traditional Wi-Fi® transmissions as the Li-Fi transmissions may reduce the availability of the Li-Fi signal. Controlling network access to a Wi-Fi® network based on location may contribute to an increase in security of the Wi-Fi® network, which may be share some similarities with the Li-Fi network in limiting the access to devices that may be beyond a transmission boundary.

In at least one example of the present disclosure, a processing device of a Wi-Fi® network may determine locations of devices within range of the Wi-Fi® transmission. The processing device may obtain a geo-fence relative to the access point and/or the range of the Wi-Fi® transmissions and the processing device may utilize the geo-fence relative to the Wi-Fi® network. Based on the locations of the devices and the geo-fence, the processing device may perform adjustments to Wi-Fi® service to devices connected and/or attempting to connect to the Wi-Fi® network.

Examples of the present disclosure will be explained with reference to the accompanying drawings.

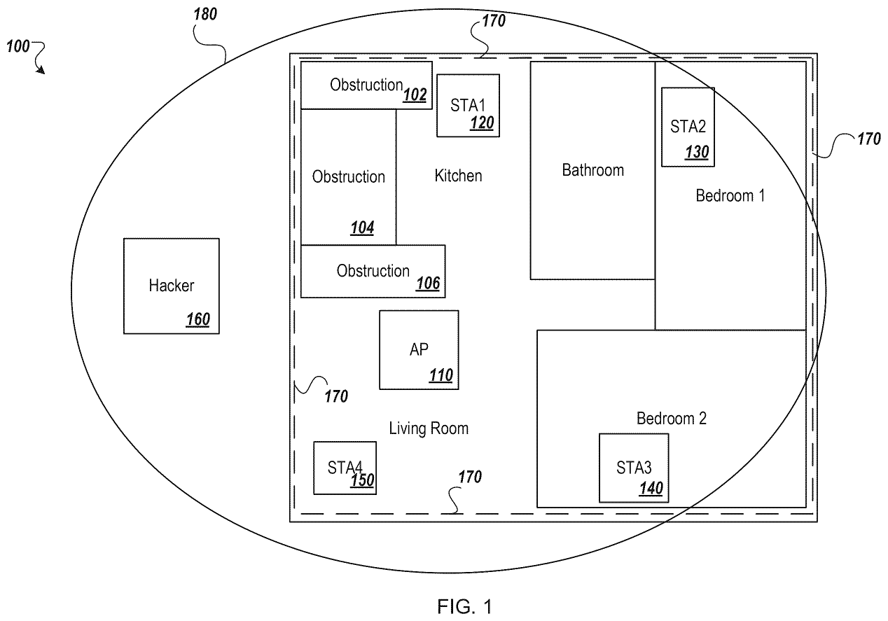

FIG. 1 illustrates an example environment 100 where a Wi-Fi® network may be located and/or operational. A Wi-Fi® network may include at least an access point 110, Wi-Fi® transmissions including a transmission range 180, and/or devices connected to the Wi-Fi® network via the access point including STA1 120, STA2 130, STA3 140, and STA4 150. As illustrated, the access point 110 may be disposed within the walls of a structure (e.g., in the “living room” as illustrated), the transmission range 180 may be the circular area around the access point 110, some of the devices (e.g., STA1 120, STA2 130, STA3 140, and STA4 150) may be disposed about an interior portion of the structure, and at least one remote device (e.g., hacker 160) may be disposed in an external portion of the structure. It will be appreciated that the transmission range 180 may vary, such as based on a number of objects obstructing the path thereof (e.g., obstructions 102, 104, 106), environmental effects to Wi-Fi® transmissions, and/or other factors that may affect the Wi-Fi® transmissions.

In some instances, it may be desirable to facilitate Wi-Fi® access (e.g., able to connect to the Wi-Fi® network) to the devices located within the structure (e.g., STA1 120, STA2 130, STA3 140, and STA4 150) and/or it may be desirable to limit and/or restrict Wi-Fi® access to the remote device disposed outside of the structure (e.g., hacker 160), as the transmission range 180 of the Wi-Fi® network may extend beyond the walls of the structure. In such instances, the processing device may obtain data associated with the Wi-Fi® network and/or the devices connected (or attempting to connect) to the Wi-Fi® network, and the processing device may manage access to the Wi-Fi® network based on the obtained data.

In some examples, the processing device may identify the devices connected to the Wi-Fi® network and/or the processing device may maintain a record of the devices that may connect to the Wi-Fi® network, which may be used to improve security in the Wi-Fi® network. For example, the processing device may identify a first device connecting to the Wi-Fi® network and may determine the first device is a trusted device. The processing device may facilitate faster subsequent attempts to connect to the Wi-Fi® network by the first device (and/or other trusted devices) and/or the processing device may enable the first device to communicate with the access point (and/or the first device may not experience limitations in the connection to the Wi-Fi® network, as described herein) when the first device is beyond the geo-fence 170 and within the transmission range 180.

The processing device may identify, at the access point (AP), the STA based on the location when the STA changes a medium access control (MAC) address. In some instances, the processing device may obtain a MAC address associated with a device that may connect and/or request to connect to the Wi-Fi network (e.g., STA1 120, STA2 130, STA3 140, STA4 150, hacker 160). In such instances, the processing device may retain the MAC address from trusted devices and manage access to the Wi-Fi network for the trusted devices in view of the MAC address known by the processing device. Alternatively, or additionally, in instances in which the Wi-Fi® network includes MAC address randomization, the processing device may obtain or derive a device fingerprint using the MAC address (or any other identifier, information, or data including a random number) which the processing device may use to verify and/or track the device while connected to the Wi-Fi® network. In such instances, the processing device may monitor and/or track the location of a device within the Wi-Fi® network.

The processing device may obtain the data from one or more sources, and the processing device may utilize the data to manage Wi-Fi® network access to devices connected to the Wi-Fi® network and/or to devices requesting access to the Wi-Fi network. The processing device may identify, at the AP, one or more of sounding data, channel state information (CSI), beamforming matrix, or round trip timing (RTT) for a STA (e.g., STA 1 120, STA2 130, STA 3 140, STA4 150, hacker 160). In some instances, the data may be generated by the access point 110 and/or may be generated using one or more device location techniques, which may include, but not be limited to, sounding, CSI, beamforming and/or a beamforming matrix, and/or round-trip timing.

The processing device may utilize sounding to measure channel properties, such as between the access point 110 and the devices (e.g., STA 1 120, STA2 130, STA 3 140, STA4 150, hacker 160). In some instances, the processing device may obtain and/or analyze signal travel times between a transmitting device (e.g., the access point 110) and a receiving device (e.g., one of the devices (e.g., STA 1 120, STA2 130, STA 3 140, STA4 150, hacker 160)) and/or record alterations in the signal travel times for a device relative to the access point 110. In some instances, the sounding based on the signal travel times may be used in one or more triangulation calculations to determine or contribute to determining the locations of the devices in the Wi-Fi® network or the devices attempting to connect to the Wi-Fi® network.

The channel state information may provide insights in the channel conditions associated with the Wi-Fi® network, which may include information regarding how various environmental factors may affect the Wi-Fi® network channel conditions. In some instances, an analysis on the channel state information may contribute to detecting environmental changes relative to the access point 110, which may be used in device fingerprinting of a device and/or movement detection of the device.

The channel state information may include information about the state of the Wi-Fi® channel. In some instances, the channel state information may be used in one or more physical layer (PHY) later operations in the Wi-Fi® network. For example, the channel state information may be used for singular value decomposition (SVD) in multiple-input multiple-output (MIMO) systems. In some instances, the V matrix from an SVD may represent optimal precoding (e.g., transmit beamforming) directions in a MIMO system, which may be used to maximize the capacity of the Wi-Fi® channel. In some examples, wireless local area network (WLAN) sensing may utilize the Wi-Fi® network for various applications, such as emotion recognition and/or human presence detection (and/or object detection based on changes determined to the Wi-Fi® channel) and WLAN sensing may become standardized in future IEEE 802.11 standards, such as 802.11bf. For example, 802.11bf may include perform data interpretation using at least the channel state information, the SVD, and/or other signal processing methods.

In some instances, the access point 110 may include multiple antennas that may be used in concert with one another to perform a beamforming operation, which may direct a signal (e.g., a Wi-Fi® transmission) from the access point 110 to one of the devices (e.g., STA 1 120, STA2 130, STA 3 140, STA4 150, hacker 160). As a Wi-Fi® transmission is directed to a particular device and the particular device moves (e.g., changes physical location), the beamforming directed by the processing device may adjust the direction of the signal based on the movement of the particular device. The processing device may utilize the beamforming data from the access point relative to the particular device to contribute to determining a particular location associated with the particular device (which may include as the particular device moves relative to the access point 110, such as within the structure and/or within the transmission range).

In some instances, the processing device may determine round trip timing associated with a signal transmitted from the access point 110 to a particular device and the back from the particular device to the access point 110. In some instances, the processing device may utilize the round trip timing to contribute to determining a location (e.g., a distance between the particular device and the access point 110) of particular devices within the transmission range and/or devices that may be connected and/or attempting to connect to the Wi-Fi® network. For example, the processing device may use the time of flight data associated with the round trip timing to refine (e.g., improve the accuracy of the estimate) a determined location of the particular device.

The processing device may compute, at the AP, a location for the STA based on the one or more of the sounding data, the CSI, the beamforming matrix, or the RTT in which the location may be computed relative to a geo-fence. In these and other examples, the processing device may integrate one or more of the device location techniques to determine a location associated with a device that may be connected to the Wi-Fi network and/or with a device attempting to connect to the Wi-Fi network (e.g., STA 1 120, STA2 130, STA 3 140, STA4 150, hacker 160). The sounding data, the channel state information, the beamforming matrix, the round-trip timing, or the like may be historical data and/or real-time data.

The processing device may perform signal processing operations and/or machine learning/artificial intelligence (AI) to further refine the location information associated with a device in the Wi-Fi network. For example, the processing device may compute, at the AP, the location for the STA using artificial intelligence, deep learning, or the like. Some examples of artificial intelligence that may be used include unsupervised learning, supervised learning (such as classification, regression), or the like. Artificial intelligence may use techniques such as search and optimization (e.g., state space search, local search), logic, probabilistic methods, statistical learning methods, artificial neural networks, or the like. Some examples of deep learning may include various architectures such as fully connected networks, deep belief networks, recurrent neural networks, convolutional neural networks, generative adversarial networks, transformers, neural radiance fields, or the like. Deep learning may be used for classification, regression, representation learning, or the like.

The processing device may compute, at the AP, a network access for the STA based on the location relative to the geo-fence 170. In some examples, the processing device may obtain a service map that may be used to establish the geo-fence 170 relative to the access point and/or relative to the structure. As illustrated in FIG. 1, the geo-fence 170 may be the dashed red line corresponding to the exterior walls of the structure, and at least a first portion of the transmission range 180 may be disposed within the geo-fence 170 and a second portion of the transmission range 180 may be disposed external to the geo-fence 170.

The processing device may generate, at the AP, the geo-fence 170 based on a service map. In some instances, the processing device may establish the geo-fence 170 using data obtained by the processing device, which may be provided by a user and/or may be determined based on devices connected to the Wi-Fi® network (e.g., STA 1 120, STA2 130, STA 3 140, STA4 150, hacker 160). In a first instance, a service map may be provided to the processing device. For example, lengths of walls of the structure may be provided to the processing device and the processing device may establish the geo-fence 170 based on the measurements included in the service map.

The processing device may generate, at the AP, the geo-fence 170 based on historical or present locations of one or more STAs connected to the AP. In one instance, the geo-fence 170 may be established based on current locations of devices connected to the Wi-Fi® network. For example, the processing device may obtain locations associated with the devices connected to the Wi-Fi® network and may initialize and/or update the geo-fence 170 based on the determined locations.

In another instance, a user of the Wi-Fi® network may submit a map to be used in determining the geo-fence 170 by connecting to the Wi-Fi® network and traversing the boundary for the geo-fence 170. For example, a person may connect a user device to the Wi-Fi® network, notify the processing device that the user device may be used to generate a map for a geo-fence 170, and the person may traverse a boundary while holding the user device, where the boundary may be used to establish the geo-fence 170.

In another instance, the processing device may determine the geo-fence 170 based on a location history of particular devices connected to the Wi-Fi® network. For example, based on a location history associated with one or more devices (e.g., relative to the structure and/or the access point 110), the processing device may determine a geo-fence 170 that includes common locations and/or the geo-fence 170 may exclude uncommon locations within the transmission range and/or within the structure. Alternatively, or additionally, the processing device may determine common locations and may fit a geometric shape to enclose the common locations. For example, upon determining two or more common locations, the processing device may fit a rectangular shape to enclose the common locations and the processing device may use the rectangular shape for the geo-fence 170.

In these and other examples, the processing device may dynamically adjust and/or improve the location of the geo-fence 170 over time. For example, an initial geo-fence may be established by the processing device (e.g., using one or more of the methods described herein), and in response to channel state information gathered from one or more devices connected to the Wi-Fi network, the processing device may adjust the location of the geo-fence 170, such as relative to the structure and/or the access point 110. In another example, the structure may be a personal home and an initial geo-fence may be established around the walls thereof. An outdoor patio may be added to the home, such that one or more devices connected to the Wi-Fi network may be located outside the initial geo-fence (e.g., as the patio may extend beyond the initial geo-fence), and the processing device may determine an adjusted geo-fence to include the patio location, based on an increase in device locations correlating to the patio.

The processing device may implement ML/AI to adjust the location of the geo-fence 170, such as based on the channel state information, the obtained locations of devices connected to the Wi-Fi® network, times of day in which the devices are connected and/or using the Wi-Fi® network, and/or other data that may be obtained by the processing device during operation of the Wi-Fi® network. For example, in instances in which a first device has been observed connecting to the Wi-Fi® network in a first location at a first time of day, the first location and during the first time of day may be included within the geo-fence 170. Continuing the example, in instances in which the first device is observed connecting to the Wi-Fi® network in a second location at the first time of day, the processing device may dynamically update the geo-fence 170 and/or the network access, such that the first location at the first time of day may no longer be within the geo-fence 170 and the second location at the first time of day may be included within the geo-fence 170. The processing device may dynamically adapt as devices connected to the Wi-Fi® network adjust connectivity patterns to the Wi-Fi® network.

In some examples, the processing device may compute, at the AP, a usage pattern for the STA in which the usage pattern may be based on time-of-day usage. The processing device may compute, at the AP, the network access for the STA based on the usage pattern.

In some instances, the processing device may control and/or adjust access to the Wi-Fi® network based on a device location, including the device location relative to the geo-fence 170. For example, referring to FIG. 1, the processing device may allow full access to the Wi-Fi® network to devices disposed within the geo-fence 170, based on the locations of the devices disposed within the geo-fence 170 (e.g., STA1 120, STA2 130, STA3 140, STA4 150), and the processing device may allow limited access and/or restrict access to the Wi-Fi® network to the remote device disposed without the geo-fence 170 (e.g., hacker 160), based on the location of the remote device being outside the geo-fence 170. In some instances, the remote device may be able to access the internet via the Wi-Fi® network and may not be able to communicate/identify other devices connected to the Wi-Fi® network, based on network access granted by the processing device to the remote device. Alternatively, or additionally, the processing device may throttle bandwidth delivered to the remote device relative to the devices connected to the Wi-Fi® network within the geo-fence 170, which may cause better connectivity to the devices within the geo-fence 170 relative to the connectivity of the remote device. Network access and/or the control thereof by the processing device may include access to the internet via the Wi-Fi® network, communications with other devices connected to the Wi-Fi® network, throughput and/or bandwidth throttling to devices connected to the Wi-Fi® network, and so forth.

The processing device may compute, at the AP, reduced network access for the STA when the location is outside the geo-fence 170. The processing device may limit and/or restrict access of the remote device to the Wi-Fi® network based on the location of the remote device relative to the geo-fence 170. For example, in instances in which the remote device is outside the geo-fence 170, the processing device may automatically limit the remote device to internet access using the Wi-Fi® network, and/or the processing device may automatically isolate the remote device from the devices within the geo-fence 170.

Alternatively, or additionally, in instances in which a particular device initially disposed within the geo-fence 170 is relocated outside the geo-fence 170, the processing device may adjust the access to the Wi-Fi® network by the particular device in response to the particular device moving without the geo-fence 170. In some instances, the processing device may facilitate full network access to the Wi-Fi® network for the particular device outside the geo-fence 170, such as instances in which the particular device first connects to and/or authenticates with the Wi-Fi® network within the geo-fence 170 and subsequently attempts to connect to the Wi-Fi® network without the geo-fence 170 (e.g., the processing device identifies the particular device upon connection within the geo-fence 170 and uses the identification thereof when the particular device attempts to connect to the Wi-Fi® network without the geo-fence 170).

In some examples, the processing device may implement ML/AI to learn and/or apply network access controls to devices connected to and/or attempting to connect to the Wi-Fi® network. In some instances, ML/AI implemented by the processing device may identify device usage patterns associated with device locations relative to the geo-fence 170 and the processing device may automatically adjust network access in view of the device usage patterns.

In some instances, the ML/AI implemented by the processing device may adjust network access for the devices connected to the Wi-Fi® network based on additional data that may be in addition to or in the alternative to the location data, as described herein (e.g., location relative to the geo-fence 170). For example, the processing device may use a time of day associated with a device requesting access to the Wi-Fi® network to determine whether network access may be granted to the requesting device. For example, the geo-fence 170 may be adjusted based on time of day, where the geo-fence 170 may be a first size and/or orientation at a first time of day, and the processing device may automatically adjust the geo-fence 170 to be a different size and/or orientation at a second time of day.

Changes made by the processing device (e.g., in view of determinations made by the ML/AI associated with the processing device) may be in view multiple data inputs, such as a location associated with a particular device and a time of day associated with the request to access the Wi-Fi® network. For example, the processing device may enable access to the Wi-Fi® network for a first device in a first location and at a first time, and the processing device may restrict (or modify) access to the Wi-Fi® network for the first device in the first location and at a second time (e.g., the processing device may allow a device to access to the Wi-Fi® network in a room in a building during the daytime and the processing device may restrict the device to access to the Wi-Fi® network in the room in the building during the nighttime). The processing device may dynamically adjust access to the Wi-Fi® network based on usage data of devices connected to the Wi-Fi® network, usage patterns detected over a period of time, and/or other factors and data that may be obtained by the processing device. Alternatively, or additionally, the processing device may dynamically adjust the geo-fence 170.

In instances in which a remote device (e.g., disposed without the geo-fence 170) attempts to connect to the Wi-Fi® network, the processing device may automatically limit and/or restrict access of the remote device to the Wi-Fi® network. Alternatively, or additionally, the processing device may generate and/or transmit an alert to an administrator of the Wi-Fi® network to determine how to handle the remote device and the network access to be allowed to the remote device. The processing device may generate, at the AP, an alert when the location is outside the geo-fence 170. In some instances, the processing device may adapt to learn the response from the administrator and apply the actions taken by the administrator to handle the network access of the remote device in subsequent attempts to connect to the Wi-Fi® network. Alternatively, or additionally, the processing device may contact the administrator (as described) and may implement an initial handling of the remote device request to access the Wi-Fi® network. In some examples, the processing device may be provided (such as from the administrator) one or more rules directing the handling of remote devices attempting to connect to the Wi-Fi® network, and the processing device may automatically execute the rules in view of the data obtained. Alternatively or additionally, the processing device may adjust, at the AP, network access dynamically based on a user experience.

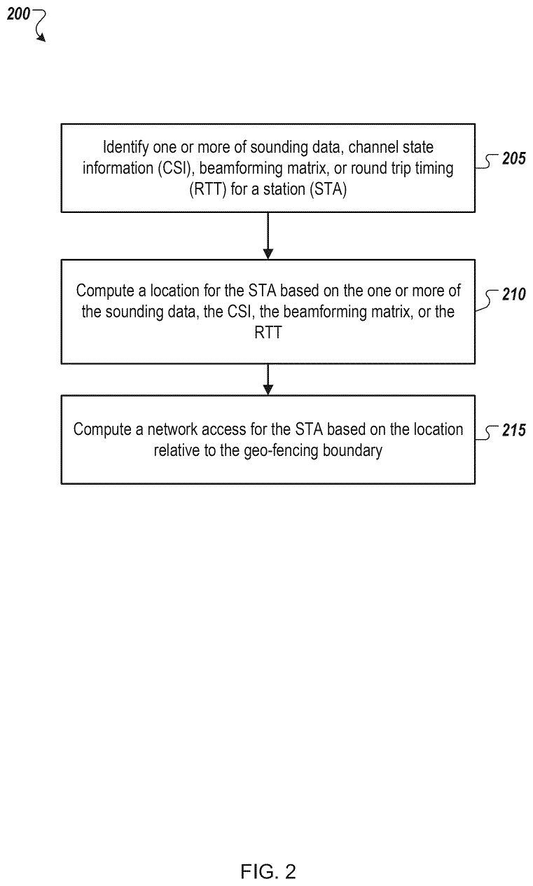

FIG. 2 illustrates a process flow of an example method 200 of location-based security, in accordance with at least one example described in the present disclosure. The method 200 may be arranged in accordance with at least one example described in the present disclosure.

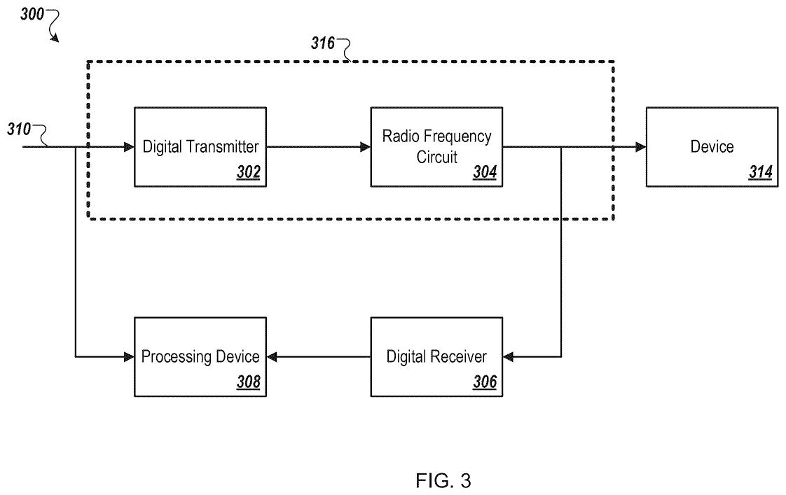

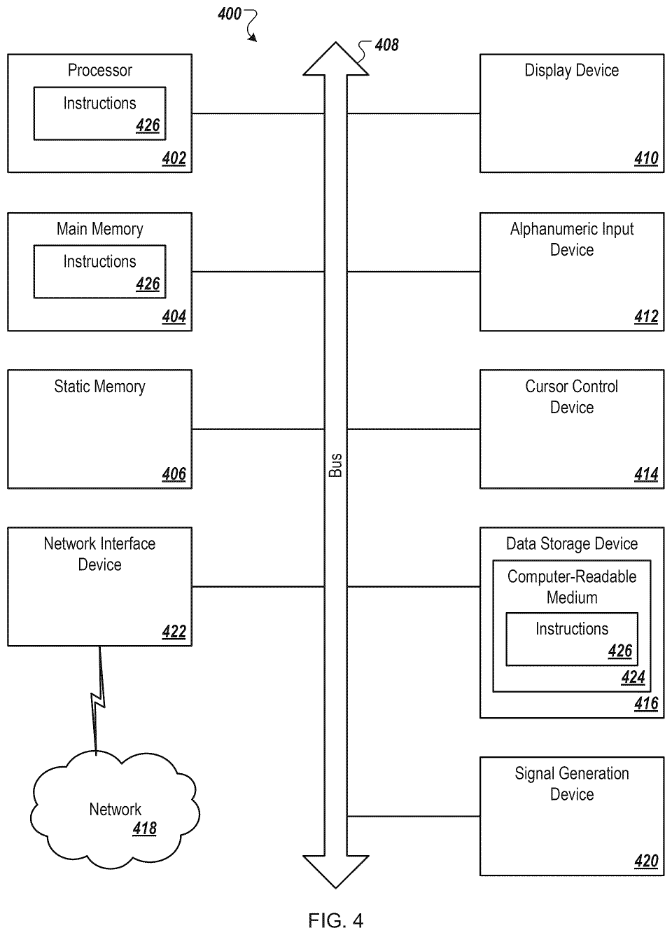

The method 200 may be performed by processing logic that may include hardware (circuitry, dedicated logic, etc.), software (such as is run on a computer system or a dedicated machine), or a combination of both, which processing logic may be included in the processing device 402 of FIG. 4, the communication system 300 of FIG. 3, or another device, combination of devices, or systems.

The method 200 may begin at block 205 where the processing logic may identify, at an AP, one or more of sounding data, CSI, beamforming matrix, or RTT for a STA.

At block 210, the processing logic may compute, at the AP, a location for the STA based on the one or more of the sounding data, the CSI, the beamforming matrix, or the RTT in which the location is computed relative to a geo-fence.

At block 215, the processing logic may compute, at the AP, a network access for the STA based on the location relative to the geo-fence.

Modifications, additions, or omissions may be made to the method 200 without departing from the scope of the present disclosure. For example, in some examples, the method 200 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 illustrates a block diagram of an example communication system 300 for location-based security, in accordance with at least one example described in the present disclosure. The communication system 300 may include a digital transmitter 302, a radio frequency circuit 304, a device 314, a digital receiver 306, and a processing device 308. The digital transmitter 302 and the processing device may receive a baseband signal via connection 310. A transceiver 316 may include the digital transmitter 302 and the radio frequency circuit 304.

In some examples, the communication system 300 may include a system of devices that may communicate with one another via a wired or wireline connection. For example, a wired connection in the communication system 300 may include one or more Ethernet cables, one or more fiber-optic cables, and/or other similar wired communication mediums. Alternatively, or additionally, the communication system 300 may include a system of devices that may communicate via one or more wireless connections. For example, the communication system 300 may include one or more devices that may transmit and/or receive radio waves, microwaves, ultrasonic waves, optical waves, electromagnetic induction, and/or similar wireless communications. Alternatively, or additionally, the communication system 300 may include combinations of wireless and/or wired connections. In these and other examples, the communication system 300 may include one or more devices that may obtain a baseband signal, perform one or more operations to the baseband signal to generate a modified baseband signal, and transmit the modified baseband signal, such as to one or more loads.

In some examples, the communication system 300 may include one or more communication channels that may communicatively couple systems and/or devices included in the communication system 300. For example, the transceiver 316 may be communicatively coupled to the device 314.

In some examples, the transceiver 316 may obtain a baseband signal. For example, as described herein, the transceiver 316 may generate a baseband signal and/or receive a baseband signal from another device. In some examples, the transceiver 316 may transmit the baseband signal. For example, upon obtaining the baseband signal, the transceiver 316 may transmit the baseband signal to a separate device, such as the device 314. Alternatively, or additionally, the transceiver 316 may modify, condition, and/or transform the baseband signal in advance of transmitting the baseband signal. For example, the transceiver 316 may include a quadrature up-converter and/or a digital to analog converter (DAC) that may modify the baseband signal. Alternatively, or additionally, the transceiver 316 may include a direct radio frequency (RF) sampling converter that may modify the baseband signal.

In some examples, the digital transmitter 302 may obtain a baseband signal via connection 310. In some examples, the digital transmitter 302 may up-convert the baseband signal. For example, the digital transmitter 302 may include a quadrature up-converter to apply to the baseband signal. In some examples, the digital transmitter 302 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 302.

In some examples, the transceiver 316 may include one or more subcomponents that may be used in preparing the baseband signal and/or transmitting the baseband signal. For example, the transceiver 316 may include an RF front end (e.g., in a wireless environment) which may include a power amplifier (PA), a digital transmitter (e.g., 302), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet MAC/personal communications service (PCS), a resource controller/scheduler, and the like. In some examples, a radio (e.g., a radio frequency circuit 304) of the transceiver 316 may be synchronized with the resource controller via the S-plane device, which may contribute to high-accuracy timing with respect to a reference clock.

In some examples, the transceiver 316 may obtain the baseband signal for transmission. For example, the transceiver 316 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 316 may generate a baseband signal for transmission. In these and other examples, the transceiver 316 may transmit the baseband signal to another device, such as the device 314.

In some examples, the device 314 may receive a transmission from the transceiver 316. For example, the transceiver 316 may transmit a baseband signal to the device 314.

In some examples, the radio frequency circuit 304 may transmit the digital signal received from the digital transmitter 302. In some examples, the radio frequency circuit 304 may transmit the digital signal to the device 314 and/or the digital receiver 306. In some examples, the digital receiver 306 may receive a digital signal from the RF circuit and/or send a digital signal to the processing device 308.

In some examples, the processing device 308 may be a standalone device or system, as illustrated. Alternatively, or additionally, the processing device 308 may be a component of another device and/or system. For example, in some examples, the processing device 308 may be included in the transceiver 316. In instances in which the processing device 308 is a standalone device or system, the processing device 308 may communicate with additional devices and/or systems remote from the processing device 308, such as the transceiver 316 and/or the device 314. For example, the processing device 308 may send and/or receive transmissions from the transceiver 316 and/or the device 314. In some examples, the processing device 308 may be combined with other elements of the communication system 300.

FIG. 4 illustrates a diagrammatic representation of a machine in the example form of a computing device 400 within which a set of instructions, for causing the machine to perform any one or more of the methods discussed herein, may be executed. The computing device 400 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 400 includes a processing device 402 (e.g., a processor), a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one example, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 424 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Some portions of the detailed description refer to different modules configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSPs, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure and is not limiting. Further, one or more of the modules may be configured to perform more, fewer, and/or different operations than those described such that the modules may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

An example apparatus can include a Wireless Access Point (WAP) or a station and incorporating a VLSI processor and program code to support. An example transceiver couples via an integral modem to one of a cable, fiber or digital subscriber backbone connection to the Internet to support wireless communications, e.g. IEEE 802.11 compliant communications, on a WLAN. The WiFi stage includes a baseband stage, and the analog front end (AFE) and RF stages. In the baseband portion wireless communications transmitted to or received from each user/client/station are processed. The AFE and RF portion handles the upconversion on each of transmit paths of wireless transmissions initiated in the baseband. The RF portion also handles the downconversion of the signals received on the receive paths and passes them for further processing to the baseband.

An example apparatus can be a MIMO apparatus supporting as many as N×N discrete communication streams over N antennas. In an example the MIMO apparatus signal processing units can be implemented as N×N. In various implementations, the value of N can be 4, 6, 8, 12, 16, etc. Extended MIMO operation enables the use of up to 2N antennae in communication with another similarly equipped wireless system. It may be noted that extended MIMO systems can communicate with other wireless systems even if the systems do not have the same number of antennae, but some of the antennae of one of the stations might not be utilized, reducing optimal performance.

CSI from any of the devices described herein can be extracted independent of changes related to channel state parameters and used for spatial diagnosis services of the network such as motion detection, proximity detection, and localization which can be utilized in, for example, WLAN diagnosis, home security, health care monitoring, smart home utility control, elder care, automotive tracking and monitoring, home or mobile entertainment, automotive infotainment, and the like.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various examples of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
identify, at the AP, one or more of sounding data, channel state information (CSI), beamforming matrix, or round trip timing (RTT) for a station (STA);
compute, at the AP, a location for the STA based on the one or more of the sounding data, the CSI, the beamforming matrix, or the RTT, wherein the location is computed relative to a geo-fence; and
compute, at the AP, a network access for the STA based on the location relative to the geo-fence.

2. The access point of claim 1, wherein the processing device is further operable to:
compute, at the AP, a usage pattern for the STA, wherein the usage pattern is based on time-of-day usage; and
compute, at the AP, the network access for the STA based on the usage pattern.

3. The access point of claim 1, wherein the processing device is further operable to:
identify, at the AP, the STA based on the location when the STA changes a medium access control (MAC) address.

4. The access point of claim 1, wherein the processing device is further operable to:
compute, at the AP, the location for the STA using one or more of artificial intelligence or deep learning.

5. The access point of claim 1, wherein the processing device is further operable to:
compute, at the AP, reduced network access for the STA when the location is outside the geo-fence.

6. The access point of claim 1, wherein the one or more of the sounding data, the channel state information (CSI), the beamforming matrix, or the round trip timing (RTT) for a station (STA) is one or more of historical data or real-time data.

7. The access point of claim 1, wherein the processing device is further operable to:
generate, at the AP, an alert when the location is outside the geo-fence.

8. The access point of claim 1, wherein the processing device is further operable to:
adjust, at the AP, network access dynamically based on a user experience.

9. The access point of claim 1, wherein the processing device is further operable to:
generate, at the AP, the geo-fence based on a service map; or
generate, at the AP, the geo-fence based on historical or present locations of one or more STAs connected to the AP.

10. The access point of claim 1, wherein the processing device is further operable to:
adjust, at the AP, the geo-fence based on one or more of channel state information, locations of one or more STAs connected to the AP, or time-of-day usage for the one or more STAs connected to the AP.

11. A method, comprising:
identifying, at an access point (AP), one or more of sounding data, channel state information (CSI), beamforming matrix, or round trip timing (RTT) for a station (STA);
computing, at the AP, a location for the STA based on the one or more of the sounding data, the CSI, the beamforming matrix, or the RTT, wherein the location is computed relative to a geo-fence; and
computing, at the AP, a network access for the STA based on the location relative to the geo-fence.

12. The method of claim 11, further comprising:
computing, at the AP, a usage pattern for the STA, wherein the usage pattern is based on time-of-day usage; and
computing, at the AP, the network access for the STA based on the usage pattern.

13. The method of claim 11, further comprising:
identifying, at the AP, the STA based on the location when the STA changes a medium access control (MAC) address.

14. The method of claim 11, further comprising:
computing, at the AP, the location for the STA using one or more of artificial intelligence or deep learning.

15. The method of claim 11, further comprising:
computing, at the AP, reduced network access for the STA when the location is outside the geo-fence.

16. A computer-readable storage medium including computer executable instructions that, when executed by a processing device, cause an access point (AP) to:
identify, at the AP, one or more of sounding data, channel state information (CSI), beamforming matrix, or round trip timing (RTT) for a station (STA);
compute, at the AP, a location for the STA based on the one or more of the sounding data, the CSI, the beamforming matrix, or the RTT, wherein the location is computed relative to a geo-fence; and
compute, at the AP, a network access for the STA based on the location relative to the geo-fence.

17. The computer-readable storage medium of claim 16, wherein the instructions, when executed by the processing device, further cause the AP to:
compute, at the AP, a usage pattern for the STA, wherein the usage pattern is based on time-of-day usage; and
compute, at the AP, the network access for the STA based on the usage pattern.

18. The computer-readable storage medium of claim 16, wherein the instructions, when executed by the processing device, further cause the AP to:
identify, at the AP, the STA based on the location when the STA changes a medium access control (MAC) address.

19. The computer-readable storage medium of claim 16, wherein the instructions, when executed by the processing device, further cause the AP to:
compute, at the AP, the location for the STA using one or more of artificial intelligence or deep learning.

20. The computer-readable storage medium of claim 16, wherein the instructions, when executed by the processing device, further cause the AP to:
compute, at the AP, reduced network access for the STA when the location is outside the geo-fence.
